(19) United States
(12) Patent Application Publication
(10) Pub. No.: US 2026/0355741 A1
(43) Pub. Date: Nov. 12, 2026

(54) DEVICE FOR MEASURING SUGARS IN A SAMPLE

(71) Applicant: SULTAN QABOOS UNIVERSITY, AL KHODH (OM)

(72) Inventors: HAIDER AHMED JAFFAR AL LAWATI, Al-Khod (OM); JAVAD HASSANZADEH, Jodeiri-Tabriz (IR)

(21) Appl. No.: 19/201,462

(22) Filed: May 7, 2025

(51) Int. Cl. B01L 3/00; G01N 21/76

(52) U.S. Cl. CPC B01L 3/502715; G01N 21/76; B01L 2200/16; B01L 2300/0609; B01L 2300/0864; B01L 2300/126

(57) ABSTRACT

A microfluidic paper-based analytical device (μPAD), comprising a testing paper including a sample well, a first detection well, a first channel extending between the sample well and the first detection well, a second detection well, a second channel extending between the sample well and the second detection well, a third detection well, and a third channel extending between the sample well and the third detection well; a first enzyme and an Fe-based metal-organic framework (MOF) including a pyridine dicarboxylic acid-based ligand in each of the first, second, and third detection wells, wherein the first enzyme in the first detection well includes glucose oxidase (GOx), the first enzyme in the second detection well includes fructose dehydrogenase, and the first enzyme in the third detection well includes glucose oxidase (GOx) with invertase (IVT).

### BACKGROUND

### 1. Field

The present disclosure relates to an assay for measuring sugars and, particularly, to an assay for measuring different sugars, such as glucose, sucrose, and fructose, in food and biological samples.

### 2. Description of the Related Art

Detection of sugars plays a significant role in facilitating many types of medical diagnoses. For instance, keeping track of blood or urine glucose levels is crucial for managing diabetes and islet cell carcinoma. Blood fructose levels are used to diagnose pancreatic cancer. Monitoring sucrose concentration in blood or urine can help detect gastric damage. In addition, measuring sugar concentrations in food is essential for quality control.

Conventional sugar analysis methods mostly rely on chromatography, spectrophotometry, electrophoresis, and titration techniques. However, these methods often require expensive equipment, skilled operators, and extensive sample preparation, which can be time-consuming. As a result, they do not allow easy and rapid monitoring.

Thus, a device for measuring sugars in a sample solving the aforementioned problems is desired.

### SUMMARY

The present subject matter relates to a device for measuring sugars in a sample, such as, but not limited to, food and biological samples. The device includes a microfluidic paper-based analytical device (μPAD) configured to indicate a presence of one or more sugars in a sample solution by chemiluminescence. The μPAD obviates a need for use of sophisticated detection equipment to detect sugars. The device provides a simple and portable assay for fast and effective measurement of a variety of sugars, including, e.g., glucose, fructose, and sucrose.

An embodiment of the present subject matter relates to a microfluidic paper-based analytical device (μPAD), comprising a testing paper including a sample well, a first detection well, a first channel extending between the sample well and the first detection well, a second detection well, a second channel extending between the sample well and the second detection well, a third detection well, a third channel extending between the sample well and the third detection well; a first enzyme and an Fe-based metal-organic framework (MOF) including a pyridine dicarboxylic acid-based ligand in each of the first, second, and third detection wells, wherein the first enzyme in the first detection well includes glucose oxidase (GOx), the first enzyme in the second detection well includes fructose dehydrogenase, and the first enzyme in the third detection well includes glucose oxidase (GOx) with invertase (IVT). In an embodiment, the Fe-based metal-organic framework (MOF) does not include cerium-based materials, thereby providing a safer and more economical probe than prior analytical devices.

According to an embodiment, a microfluidic paper-based analytical device (μPAD) system includes an μPAD defined by a testing paper including a sample well, a first detection well, a first channel extending between the sample well and the first detection well, a second detection well, a second channel extending between the sample well and the second detection well, a third detection well, and a third channel extending between the sample well and the third detection well; a first enzyme and an Fe-based metal-organic framework (MOF) including a pyridine dicarboxylic acid-based ligand in each of the first, second, and third detection wells, wherein the first enzyme in the first detection well includes glucose oxidase (GOx), the first enzyme in the second detection well includes fructose dehydrogenase, and the first enzyme in the third detection well includes glucose oxidase (GOx) with invertase (IVT); and a holder for supporting the device and a smartphone, the holder including a base, an upright support extending from the base, and a tray receptacle on top of the upright support, a drawer removably positioned within the base, and an opening extending through the tray receptacle and along a length of the upright support, the microfluidic paper-based analytical device (μPAD) being removably positioned in the drawer.

These and other features of the present subject matter will become readily apparent upon further review of the following specification.

### BRIEF DESCRIPTION OF THE DRAWINGS

FIG. 1 is a plan view of the microfluidic paper-based analytical device (μPAD), according to the present teachings.

FIG. 2 is a schematic showing components of the microfluidic paper-based analytical device (μPAD) system.

FIG. 3 is an exemplary calibration graph produced by a smartphone after capturing an image of the chemiluminescent (CL) emission from all three detection zones, for the purpose of simultaneous detection of three different sugars in a sample solution (the intensity of lights was recorded by SpectraUPB and the intensity of blue light emitted from each detection zone was proportional to the corresponding sugar).

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

It will be understood by those skilled in the art with respect to any chemical group containing one or more substituents that such groups are not intended to introduce any substitution or substitution patterns that are sterically impractical and/or physically non-feasible.

Unless defined otherwise, all technical and scientific terms used herein have the same meaning as commonly understood to one of ordinary skill in the art to which the presently described subject matter pertains.

Where a range of values is provided, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

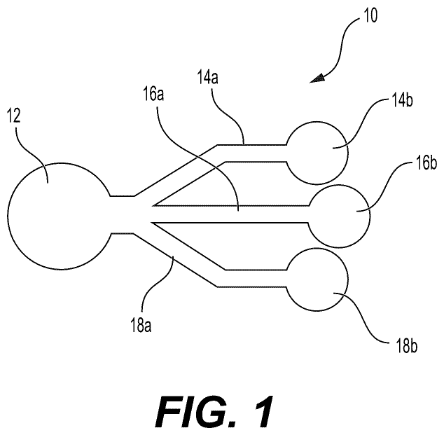

As shown in FIG. 1, an embodiment of the present subject matter relates to a microfluidic paper-based analytical device (μPAD), designated 10 in the drawings. In an embodiment, the μPAD can include a testing paper including a sample well 12, a first detection well 14b, a first channel 14a extending between the sample well 12 and the first detection well 14b, a second detection well 16b, a second channel 16a extending between the sample well 12 and the second detection well 16b, a third detection well 18b, and a third channel 18a extending between the sample well 12 and the third detection well 18b. In an embodiment, each detection well 14b, 16b, and 18b, includes a first enzyme, an Fe-based metal-organic framework (MOF), and a pyridine dicarboxylic acid-based ligand incorporated into the Fe-MOF structure.

In an embodiment, each detection well 14b, 16b, and 18b includes a second enzyme, different from the first enzyme. In an embodiment, the second enzyme is horseradish peroxidase (HRP) enzyme.

In an embodiment the first detection well can detect a presence of glucose in the sample solution and the first enzyme of the first detection well includes glucose oxidase (GOx). In an embodiment, the second detection well can detect a presence of fructose in the sample solution and the first enzyme of the second detection well includes fructose dehydrogenase. In an embodiment, the third detection well can detect a presence of sucrose and the first enzyme of the third detection well includes glucose oxidase with IVT.

A method of using the μPAD device for detecting a presence of a sugar in a sample solution can include dispensing the sample solution into the sample well; flowing the sample solution into each of the first, second and third detection wells; adding a chemiluminescent reagent to each of the first, second, and third detection wells; capturing an image of the first, second, and third detection wells after the addition of the chemiluminescent (CL) reagent to detect a chemiluminescent (CL) emission; and corresponding an intensity of blue light from the chemiluminescent (CL) emission with a respective sugar concentration. In an embodiment, the CL reagent includes luminol dissolved in sodium hydroxide (NaOH) to generate a CL emission.

An embodiment of the present teachings relates to a μPAD system 50 including a μPAD 10, a smartphone 40, and a holder 30 for the μPAD 10 and the smartphone 40. In an embodiment, the holder 30 includes a generally rectangular base 32, an upright support 34 extending from the base 32, and a tray receptacle 36 on top of the upright support 34. The tray receptacle 36 can include upright corner portions 39 to facilitate retaining a smartphone 40 thereon. The base 32 includes a removable drawer 20 within a slot 37 of the base 32 for receiving the μPAD 10. The upright support 34 includes an injection port 41. An opening 38 is defined through a side of the tray receptable 36 and extends along a length of the upright support 30.

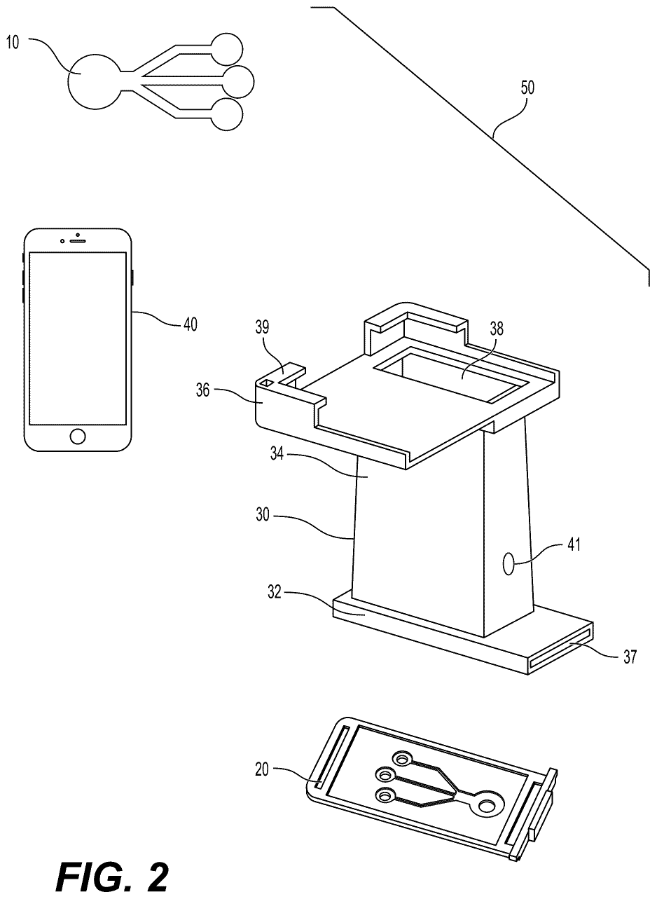

An embodiment of the present teachings relates to a method of using the μPAD system 50 for detecting a presence of a sugar in a sample solution, as shown in FIG. 2. In an embodiment, the sugar includes one or more sugars selected from the group consisting of glucose, fructose and sucrose. In an embodiment, μPAD 10 is placed in the μPAD drawer 20 and secured within the holder 30. The sample solution is then dispensed through the opening 38 into the sample well 12. Once dispensed in the sample well 12, the sample solution divides into three smaller volumes of solution while flowing into a separate one of the first, second, and third detection wells or zones.

Once in the respective detection wells, a chemiluminescent (CL) reagent is added to each sample solution in the detection wells through the injection port 41. In an embodiment, the CL reagent includes luminol dissolved in sodium hydroxide (NaOH) to generate a CL emission. In an embodiment, the method includes capturing an image of the first, second, and third detection wells using a camera, e.g., a cell phone camera, to detect a CL emission, and analyzing the captured image using an appropriate software, e.g., SpectraU PB software, for determining the maximum CL intensity (ICL) for each detection well. In an embodiment, a maximum CL intensity (ICL) corresponds to a concentration of the sugar in each detection well.

In an embodiment, the emission from each detection well of the PAD can indicate the presence of even small sample volumes, e.g., microliter volumes, of the sugar. Emission of a blue light from the μPAD can be quantitatively measured using a cell phone as a detector. The cell phone can capture and analyze the light emitted from the μPAD. In an embodiment, the system can be used to measure glucose, fructose, and sucrose levels with high accuracy, making it a highly promising candidate for point-of-care (POC) testing in food quality control and medical applications.

According to an embodiment, a small volume (about 50 μL) of the sample can be injected into the sample well of the μPAD through the opening in the tray receptacle and allowed to stand for a period of time, e.g., about 5 minutes. Afterwards, the chemiluminescent (CL) reagent solution can be injected into each detection well through the injection port using a micropipette. A cell phone camera can then be placed on the tray receptacle such that the lens is placed over the opening.

The present teachings are illustrated by the following Examples.

### EXAMPLES

### Example 1

Preparation of paper device

Whatman filter papers (UK) were used to prepare the μPADs. The filter papers were cut to the desired design using a cutter machine (Silhouette Cameo, USA). Three detection wells or zones were respectively configured for detection of three different sugars (glucose, fructose, and sucrose). A sampling well or zone was configured for receiving an injected sample solution. Although three detection wells were provided, the number of detection zones can vary based on the types of sugars to be detected. A paper and smartphone holder, designed in AutoCAD 2024, was prepared using a Flashforge 3D printer (Creator 4S, China). A Huawei P20 Pro phone (China) and SpectraUPB software were used to record and analyze the emitted chemiluminescence light from the papers.

In-situ synthesis of defective MOF on paper. A metal organic framework (MOF) paper device (μPAD) was synthesized directly on the papers including the sample and detection wells by directly contacting the papers with Fe-BTC₍₁₋ₓ₎PyDC₍ₓ₎ to provide a MOF/FeBP-x; where BTC=1,3,5-benzene dicarboxylate, PyDC=pyridine-3,5-dicarboxylate, and x shows the fraction of PyDC ligand in the MOF. A defective metal organic framework was formed by inserting a small amount of ditopic linker (PyDC) into an iron metal organic framework (Fe-MOF) including mainly 1,3,5-benzene dicarboxylate (BTC), a tritopic linker. The papers were immersed into a ligand solution (BTC(1-x mM)+PyDC(x mM)), methanol (to wash excess and unreacted reagents), cation solution (Fe³⁺, 1 mM), and methanol (to wash excess and unreacted reagents), respectively. The cycle was repeated 15 times to complete the synthesis process. The appearance of a brown color on the papers verified the generation of MOF crystals. The papers were finally dried in an oven (50° C., 30 min), carefully covered, and reserved for analytical purposes.

Modification with enzymes. Each detection zone was modified with a special enzyme, depending on the sugar to be measured. For example, to measure glucose, the paper was modified with glucose oxidase (GOx) by adding the enzyme solution (5 μL, 100 U mL⁻¹) on the detection zone of the MOF-modified paper device. Fructose dehydrogenase (FDH, 50 U mL⁻¹) together with K₃Fe(CN)₆ (5 μL, 0.05 mol L⁻¹) was used for fructose measurement. GOx (100 U mL⁻¹) together with IVT (80 U mL⁻¹) were used for the detection of sucrose. Then, the μPADs were dried in an oven (50° C., 10 min), covered carefully, and kept at 2° C. In this condition, the μPADs were stable for at least 10 weeks.

To enhance the detection process, horseradish peroxidase (HRP) enzyme was added to the papers. After modification of the pristine papers (without MOF) with sugar enzymes (as mentioned above), the papers were treated with 5 μL HRP solution (0.02 mg mL⁻¹, prepared in phosphate buffer, pH 7.4). Then, the μPADs were dried in an oven (50° C., 10 min.), covered carefully, and kept at 2° C. In this condition, the μPADs were stable for at least 2 weeks.

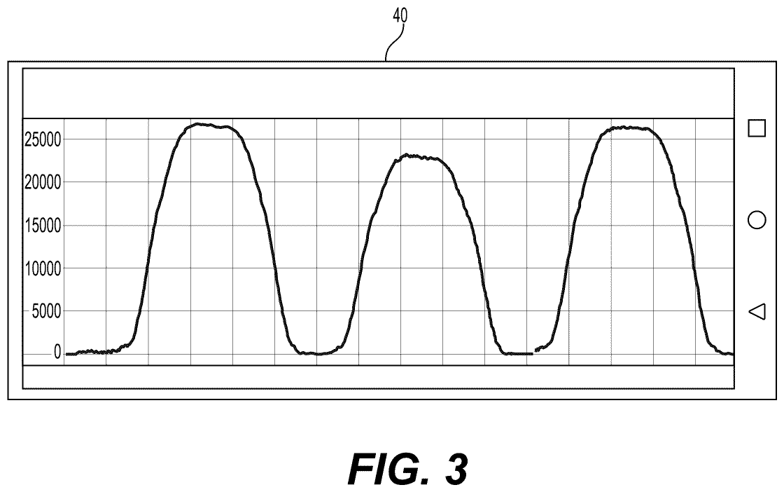

Detection process. The μPAD was placed in the drawer and secured within the holder. A small volume of real sample or standard solution of sugars (50 μL) was injected into the sampling zone and allowed to stand for 5 min. Finally, 3 μL of CL reagent solution (luminol 0.5 mM, in 0.05 M NaOH) was injected in each detection well, using a micropipette. The generated CL emission was recorded using the cell phone camera and analyzed with SpectraUPB software. The maximum CL intensity (IL) for each detection well provided an analytical signal which corresponded to the analyte concentration of each detection well using a calibration graph (FIG. 3).

It is to be understood that the microfluidic paper-based analytical device (μPAD) is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A microfluidic paper-based analytical device (μPAD), comprising:
a testing paper including a sample well, a first detection well, a first channel extending between the sample well and the first detection well, a second detection well, a second channel extending between the sample well and the second detection well, a third detection well, and a third channel extending between the sample well and the third detection well;
a first enzyme and a Fe-based metal-organic framework (MOF) including a pyridine dicarboxylic acid-based ligand in each of the first, second, and third detection wells,
a second enzyme different from the first enzyme in each of the first, second, and third detection wells,
wherein the first enzyme in the first detection well includes glucose oxidase (GOx), the first enzyme in the second detection well includes fructose dehydrogenase, and the first enzyme in the third detection well includes glucose oxidase (GOx) with invertase (IVT),
wherein the second enzyme is a horseradish peroxidase (HRP) enzyme prepared in a phosphate buffer with a pH of 7.4, and
wherein the Fe-based metal-organic framework (MOF) excludes cerium based materials.

2. (canceled)

3. (canceled)

4. A method of using the microfluidic paper-based analytical device (μPAD) of claim 1 for detecting a presence of a sugar in a sample solution, comprising:
dispensing the sample solution into the sample well;
flowing the sample solution into each of the first, second and third detection wells;
adding a chemiluminescent reagent to each of the first, second, and third detection wells;
capturing an image of the first, second, and third detection wells after the addition of the chemiluminescent (CL) reagent to detect a chemiluminescent (CL) emission; and
corresponding an intensity of blue light from the chemiluminescent (CL) emission with a respective sugar concentration.

5. The method of claim 4, wherein the sugar includes one or more selected from the group consisting of glucose, fructose, and sugar.

6. The method of claim 4, wherein the chemiluminescent (CL) reagent comprises luminol dissolved in sodium hydroxide (NaOH).

7. A microfluidic paper-based analytical device (μPAD) system, comprising:
the device of claim 1; and
a holder for supporting the device and a smartphone, the holder including a base, an upright support extending from the base, and a tray receptacle on top of the upright support, a drawer removably positioned within the base, and an opening extending through the tray receptacle and along a length of the upright support, the microfluidic paper-based analytical device (μPAD) being removably positioned in the drawer.

8. The microfluidic paper-based analytical device (μPAD) of claim 7,
wherein the upright support includes an injection port.

9. A method of using the μPAD system of claim 7 for detecting a presence of a sugar in a sample solution, comprising:
placing the microfluidic, paper-based analytical device (μPAD) on the drawer;
securing the drawer within the housing;
dispensing the sample solution through the opening onto the sample well;
flowing the sample solution into each of the first, second and third detection wells;
adding a chemiluminescent reagent to each of the first, second, and third detection wells;
capturing an image of the first, second, and third detection wells after the addition of the chemiluminescent (CL) reagent to detect a chemiluminescent (CL) emission; and
corresponding an intensity of blue light from the chemiluminescent (CL) emission with a respective sugar concentration.

10. The method of claim 9, wherein the sugar includes one or more selected from the group consisting of glucose, fructose, and sugar.

11. The method of claim 9, wherein the chemiluminescent (CL) reagent comprises luminol dissolved in sodium hydroxide (NaOH).

12. A microfluidic paper-based analytical device (μPAD) system, comprising:
a microfluidic paper-based analytical device (μPAD) comprising a testing paper including a sample well, a first detection well, a first channel extending between the sample well and the first detection well, a second detection well, a second channel extending between the sample well and the second detection well, a third detection well, and a third channel extending between the sample well and the third detection well;
a first enzyme and an Fe-based metal-organic framework (MOF) including a pyridine dicarboxylic acid-based ligand disposed in each of the first, second, and third detection wells, wherein
the first enzyme in the first detection well includes glucose oxidase (GOx), the first enzyme in the second detection well includes fructose dehydrogenase, and the first enzyme in the third detection well includes glucose oxidase (GOx) with invertase (IVT); and
a holder for supporting the device and a smartphone, the holder including a base, an upright support extending from the base, and a tray receptacle on top of the upright support, a drawer removably positioned within the base, an opening extending through the tray receptacle and along a length of the upright support, and an injection port defined in the upright support, the microfluidic paper-based analytical device (μPAD) being removably positioned in the drawer.

13. The microfluidic paper-based analytical device (μPAD) device of claim 12, further comprising a second enzyme different from the first enzyme in each of the first, second, and third detection wells.

14. The microfluidic paper-based analytical device (μPAD) system of claim 12, wherein the second enzyme is horseradish peroxidase (HRP) enzyme.

15. A method of using the μPAD system of claim 12 for detecting a presence of a sugar in a sample solution, comprising:
placing the microfluidic paper-based analytical device (μPAD) on the drawer;
securing the drawer within the housing;
dispensing the sample solution through the opening onto the sample well;
flowing of the sample solution into each of the first, second and third detection wells;
adding a chemiluminescent reagent to each of the first, second, and third detection wells;
capturing an image of the first, second, and third detection wells after the addition of the chemiluminescent (CL) reagent to detect a chemiluminescent (CL) emission;
corresponding an intensity of blue light from the chemiluminescent (CL) emission with a respective sugar concentration.

16. The method of claim 15, wherein the sugar includes one or more selected from the group consisting of glucose, fructose, and sugar.

17. The method of claim 15, wherein the chemiluminescent (CL) reagent comprises luminol dissolved in sodium hydroxide (NaOH).
